(19) United States
(12) Patent Application Publication
(10) Pub. No.: US 2017/0371564 A1
(43) Pub. Date: Dec. 28, 2017

(54) METHOD AND APPARATUS FOR MEMORY EFFICIENCY IMPROVEMENT BY PROVIDING BURST MEMORY ACCESS CONTROL

(71) Applicant: Advanced Micro Devices, Inc., Sunnyvale, CA (US)

(72) Inventors: Shuzhi Hou, Austin, TX (US); Sadagopan Srinivasan, Austin, TX (US); Daniel L. Bouvier, Austin, TX (US)

(21) Appl. No.: 15/195,006

(22) Filed: Jun. 28, 2016

(51) Int. Cl. G06F 3/06

(52) U.S. Cl. CPC G06F 3/0613; G06F 3/0683; G06F 3/0653; G06F 3/0656

(57) ABSTRACT

Methods and apparatus monitor memory access activities of non-real-time processing engines to determine time intervals when the memory access activities are low. When such time intervals are found, the methods and apparatus perform burst memory access control for real-time processing engines by bursting data from a memory to a burst memory buffer, or from the burst memory buffer to the memory, to allow fast data access by the real-time processing engines.

### BACKGROUND OF THE DISCLOSURE

The disclosure relates generally to methods and apparatus that provide memory access control during memory access.

A videoconferencing system may be used to provide an interactive video call. The system may include a remote device that captures video data, and a local device that receives the captured video data from the remote device to be rendered on a local display, or vice versa. To compress, transfer, decompress, visually enhance, and display frames of the video data, various processing engines may be involved, some of which are real-time in nature. For example, a real-time processing engine may be an input real-time processing engine such as an image signal processor, or an output real-time processing engine such as a display engine.

Real-time processing engines usually send data access requests in a constant rate driven by either a frame capture rate or a display refresh rate. Meanwhile, non-real-time processing engines send data access requests on a best effort basis.

The real-time processing engines can escalate the priority of their data access requests if the memory bandwidth requirement is not met within a specific time window. This often occurs near the end of the time window when the non-real-time processing engines grab too much memory bandwidth.

Existing solutions allow the real-time processing engines to get more bandwidth by raising the priority of their data access requests whenever the memory bandwidth falls short of the required amount. The drawback to this kind of approach is the penalty paid to memory inefficiency as memory access switching is made by force. Even before any priority escalation, it is difficult to delegate the various data access requests due to a large amount of simultaneously conflicting request streams. Memory inefficiency effectively reduces total bandwidth. This is especially true in some use case scenarios, such as a three-way videoconferencing call, where it is difficult to predict whether the three-way videoconference call can be supported in a system on chip (SoC) configuration. As such, designers need to overdesign memory subsystems, which increases system cost and power consumption. These factors, in turn, are sensitive in consumer markets, especially in the mobile market. A noticeable fact is that the real-time processing engines remain unaware of the overall system traffic. As such, isolated decisions made by the real-time processing engines can penalize themselves and the rest of the system. Therefore, an opportunity exists to improve the scheduling of traffic from the data access requests of the real-time processing engines.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of an apparatus that provides burst memory access control in accordance with one example set forth in the disclosure;

FIG. 2 is a flowchart illustrating one example of a method for providing burst memory access control in accordance with one example set forth in the disclosure;

FIG. 3 is a diagram illustrating a bandwidth profile for a display frame processing interval;

FIG. 4 is a diagram illustrating a bandwidth profile for a display frame processing interval after employing burst memory access control in accordance with one example set forth in the disclosure;

FIG. 5 is a block diagram illustrating one example of an apparatus that provides burst memory access control in accordance with one example set forth in the disclosure;

FIG. 6 is a flowchart illustrating one example of a method for burst memory access control in accordance with one example set forth in the disclosure;

FIG. 7 is a flowchart illustrating one example of a method for providing burst memory access control in accordance with one example set forth in the disclosure;

FIG. 8 is a block diagram illustrating one example of a videoconferencing system that provides burst memory access control in accordance with one example set forth in the disclosure;

FIG. 9 is a graph illustrating bandwidth efficiency loss without burst memory access control;

FIG. 10 is a graph illustrating bandwidth efficiency improvement with burst memory access control in accordance with one example set forth in the disclosure; and

FIG. 11 is a block diagram illustrating one example of an apparatus that provides burst memory access control and service rate monitoring in accordance with one example set forth in the disclosure.

### DETAILED DESCRIPTION OF THE PREFERRED EMBODIMENTS

Briefly, methods and apparatus monitor memory access activities of non-real-time processing engines, such as a graphics processing unit or other suitable engines, to determine time intervals when the memory access activities are low. When such time intervals are found, the methods and apparatus perform burst memory access control for real-time processing engines, such as a display engine or other suitable engines, by bursting data for the real-time processing engines from memory to a burst memory buffer, or from the burst memory buffer to the memory, to allow fast data access by the real-time processing engines.

Among other advantages, the methods and apparatus can improve the scheduling of data access requests from real-time processing engines by considering data access requests from other non-real-time processing engines. In doing so, the methods and apparatus determine durations in which memory access activities of the other non-real-time processing engines are low. The methods and apparatus then burst data for the real-time processing engines from a memory to a burst memory buffer, or from the burst memory buffer to the memory, during these durations. In this manner, the methods and apparatus can schedule the data access requests of the real-time processing engines to avoid memory access conflicts with the other non-real-time processing engines and maintain a good overall throughput. It is contemplated that one application of the methods and apparatus is the use of 1333 MHz DDR3 memory chips to support 4K display devices.

In one example, a method and apparatus, in the form of a memory controller, controls memory access to a memory by determining low memory access activity durations during a display frame processing interval associated with a first processing engine, such as a non-real-time processing engine. The memory controller then controls the memory for a second processing engine, such as a real-time processing engine, during the determined low memory access activity durations to burst data for the real-time processing engine to a burst memory buffer.

The memory controller may determine the low memory access activity durations in the display frame processing interval by detecting software-hardware synchronization intervals, such as the transitional periods when different hardware is used to process the display frame, and detecting an inter-function synchronization interval, such as the transitional period between the end of processing the current display frame and the start of processing the next display frame. The memory controller may control the memory for the real-time processing engine by generating a control signal to initialize the burst memory buffer to start bursting the data for the real-time processing engine to the burst memory buffer during the determined low memory access activity durations. Accordingly, the memory controller may burst the data to the burst memory buffer by either reading the data from the memory or writing the data to the memory during the hardware-software synchronization intervals. Moreover, the memory controller may provide a signal to indicate availability of the memory controller to service memory access requests from the real-time processing engine.

The memory controller may further determine whether a memory access request is received from a third processing engine, such as another non-real-time processing engine, during the controlling of the memory for the real-time processing engine. If such request is received, the memory controller may interrupt the bursting of the data for real-time processing engine to the burst memory buffer and reestablish control of the memory for the other non-real-time processing engine. However, if no memory access request is received from the other non-real-time processing engine, the memory controller may determine whether the inter-function synchronization interval is reached. If not, the memory controller may continue to burst the data for real-time processing engine to the burst memory buffer.

In another example, a method and apparatus, in the form of a memory controller and an I/O controller, control memory access to a memory by determining low memory access activity durations during a display frame processing interval associated with a first processing engine, such as a non-real-time processing engine. The memory controller then controls the memory for a second processing engine, such as a real-time processing engine, during the determined low memory access activity durations to burst data for the real-time processing engine to a burst memory buffer.

The memory controller may include a low memory access activity duration detector that determines the low memory access activity durations. In doing so, the low memory access activity duration detector generates and transmits a control signal to the I/O controller. The memory controller may also include a memory arbiter that receives a bursting signal from the burst memory buffer to start bursting the data for the real-time processing engine to the burst memory buffer in response to transmitting the control signal to the I/O controller. Moreover, the memory controller may include a burst memory disable detector that receives a memory access request from another non-real-time processing engine during the controlling of the memory for the real-time processing engine. In response to receiving the memory access request, the burst memory disable detector generates an interrupt signal to interrupt the bursting of the data for the real-time processing engine to the burst memory buffer.

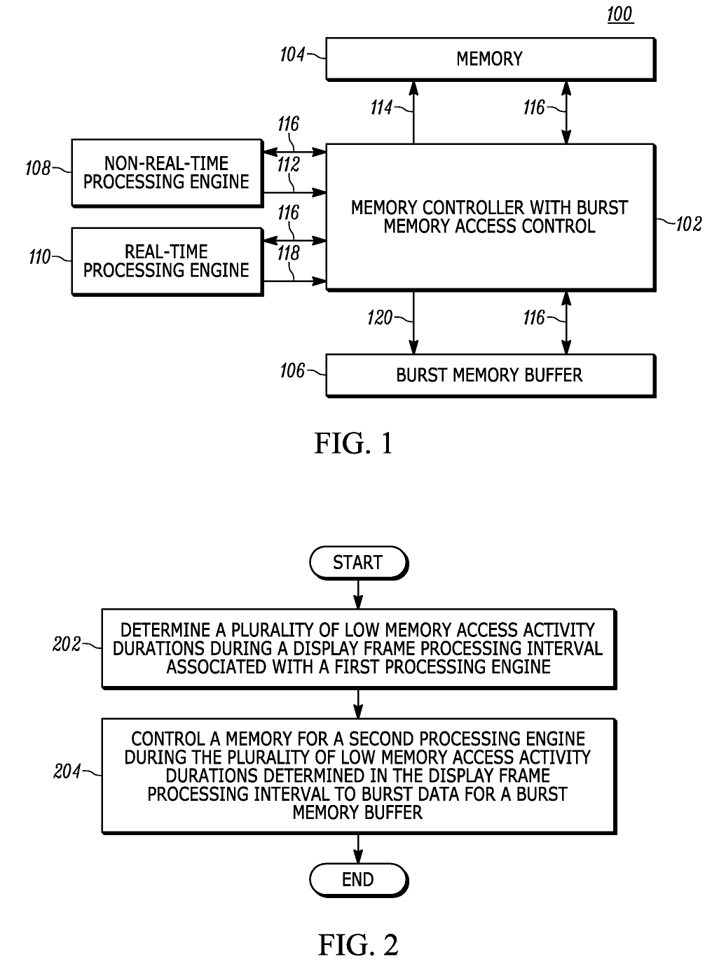

Turning now to the drawings, FIG. 1 illustrates one example of an apparatus 100 that provides burst memory access control. The apparatus 100 may be part of a device or system such as a laptop, a desktop, a smartphone, a videoconferencing system, a virtual reality device, a video projector, a high-definition television (HDTV), etc. As shown, the apparatus 100 includes, among other things, a memory controller with burst memory access control 102 operatively coupled to a memory 104 and a burst memory buffer 106. The memory controller 102 performs a wide range of memory control related functions to manage the flow of data going to and from the memory 104. In addition, the memory controller 102 performs burst memory access control that regulates the bursting of data from the memory 104 to the burst memory buffer 106 and vice versa. Bursting data typically involves either reading or writing a fixed number of bytes, or reading or writing a continuous stream of bytes in sequence without interruption beginning from a starting address. By employing burst memory access control, the memory controller 102 is able to provide fast access to the data in the memory 104 because the data has been pre-fetched from the memory 104 and put into the burst memory buffer 106.

The memory 104 may be a dynamic random access memory (DRAM), such as a double data rate synchronous dynamic random access memory (DDR SDRAM), a low power double data rate synchronous dynamic random access memory (LPDDR SDRAM), a graphics double data rate synchronous dynamic random access memory (GDDR SDRAM), a Rambus dynamic random access memory (RDRAM), etc., or any other suitable type of volatile memory. Although a single memory is illustrated, the memory 104 may include a plurality of memories each of which is coupled to and controlled by the memory controller 102.

As described above, the burst memory buffer 106 is used to temporarily store data for the memory 104. That is, the memory buffer 106 may temporarily store data that has been read from the memory 104, or may temporarily store data that will be written to the memo 104. The burst memory buffer 106 may be implemented using any suitable memory technology. As an example, the memory buffer 106 may be a circular memory buffer in which the data moves through on a first in-first out basis. The memory buffer 106 may also include logic for setting up operation (e.g., read/write) initiated by the memory controller 102. In some embodiments, the memory buffer 106 may be part of or reside in the memory 104.

The apparatus 100 also includes a non-real-time processing engine 108 and a real-time processing engine 110, both of which are operatively coupled to the memory controller 102. As used herein and in the context of the present invention, the term “real-time” describes the quality of a visual display having no observable latency to give a viewer the impression of continuous, realistic movement. Accordingly, the real-time processing engine 110 may be associated with an I/O device. For example, the real-time processing engine 110 may be a display engine associated with a display device or an ISP associated with an image sensor. Here, memory-mapped I/O may be implemented to allow the real-time processing engine 110 to interface with or access both the memory controller 102 and the associated I/O device. The non-real-time processing engine 108 may be any suitable instruction processing device, such as a central processing unit (CPU), an accelerated processing unit (APU), a graphics processing unit (GPU), a video codec, etc. Although two processing engines are shown to be coupled to the memory controller 102, it is to be appreciated that any suitable number of non-real-time and real-time processing engines may be coupled to the memory controller 102.

The apparatus 100 may operate to process and generate a series of display frames, which may include video, audio and/or other multimedia information. As such, the non-real-time processing engine 108 (e.g., a GPU) may send a read request (via a connection 112) to the memory controller 102 to access data (e.g., video, audio or multimedia data associated with the display frames) stored in the memory 104. In response, the memory controller 102 may issue a read command (via a connection 114) to the memory 104 to allow the non-real-time processing engine 108 to acquire the data from the memory 104 (via a data bus 116). Once acquired, the non-real-time processing engine 108 may process the data to render the display frames (e.g., by using any number of processing operations such as encoding, decoding, scaling, interpolation, antialiasing, motion compensation, noise reduction, etc.). As each display frame is rendered, the non-real-time processing engine 108 may save the rendered display frame (in the form of post-processed data) back in the memory 104. For example, the non-real-time processing engine 108 may send a write request (via the connection 112) to the memory controller 102, and in response, the memory controller 102 may issue a write command (via the connection 114) to the memory 104 to allow the non-real-time processing engine 108 to save the rendered display frame to the memory 104 (via the data bus 116).

As each display frame is rendered and saved, the real-time processing engine 110 (e.g., a display engine) may send a read request (via a connection 118) to the memory controller 102 to retrieve the rendered display frame in the memory 104 for output to a display device (e.g., a monitor). However, memory access requests often compete against each other. This is especially true because the real-time processing engine 110 must meet certain requirements in order to be considered as operating in real-time. For example, the real-time processing engine 110 requires a guaranteed memory bandwidth for accessing data during a specific time window. The real-time processing engine 110 may escalate the priority of its memory access requests if the real-time processing engine 110 sees that the required memory bandwidth has not been achieved near the end of the time window. Such priority escalation can cause conflicts as the memory access requests from the real-time processing engine 110 compete or overlap with those from the non-real-time processing engine 108.

In order to avoid this situation, the memory controller 102 may perform burst memory access control. More particularly, the memory controller 102 may monitor the memory access requests or activities of the non-real-time processing engine 108 to determine periods when the memory access activities are low. When such periods are detected, the memory controller 102 may generate and send a control signal (via a connection 120) to initialize and set up the memory buffer 106 (e.g., for a read operation). Afterward, the memory controller 102 may begin bursting data from the memory 104 to the memory buffer 106 (via the data bus 116).

In this manner, the rendered display frames saved in the memory 104 are pre-fetched to the burst memory buffer 106. The real-time processing engine 110 can then access the rendered display frames in the memory buffer 106 (via the data bus 116) for output to the display device.

Of course, data bursting can also occur from the memory buffer 106 to the memory 104. In this scenario, the real-time processing engine 110 may be associated with an input device (e.g., a camera). As such, the real-time processing engine 110 may save or transfer data captured by the input device to the memory buffer 106. Subsequently, the memory controller 102 may burst the data in the memory buffer 106 to be stored in the memory 104.

The components 102-110 may be integrated into a single chip (e.g., an integrated circuit chip). Further, the memory controller 102 and/or the processing engines 108, 110 may be implemented as an application-specific integrated circuit (ASIC), a field programmable gate array (FPGA), a programmable logic device (PLD), a state machine, or other suitable logic devices.

FIG. 2 shows an example method for providing burst memory access control. The method may be carried out by a memory controller (e.g., the memory controller 102). As shown in block 202, the method includes determining a plurality of low memory access activity durations during a display frame processing interval associated with a first processing engine. The first processing engine may be a non-real-time processing engine (e.g., the non-real-time processing engine 108). As such, the non-real-time processing engine may include one or more of a CPU, an APU, a GPU, a video codec, an audio codec or a multimedia codec.

As shown in block 204, the method includes controlling a memory (e.g., the memory 104) for a second processing engine during the plurality of low memory access activity durations determined in the display frame processing interval to burst data for a burst memory buffer (e.g., the memory buffer 106). The second processing engine may be a real-time processing engine (e.g., the real-time processing engine 110). As such, the real-time processing engine may include one or more of an image signal processor (ISP) or a display engine.

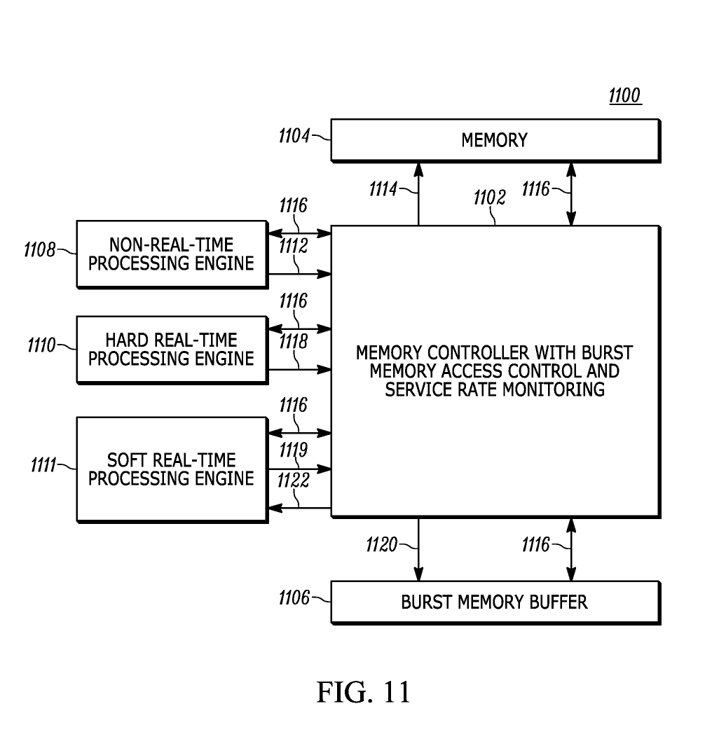

Controlling the memory for the second processing engine may include generating a control signal to initialize the burst memory buffer to start bursting the data for the burst memory buffer during the plurality of low memory access activity durations determined in the display frame processing interval. Moreover, the method may include providing a signal to indicate the availability of the memory controller to service memory access requests from the second processing engine. This is referred to as service rate monitoring, which will be described in more detail in FIG. 11.

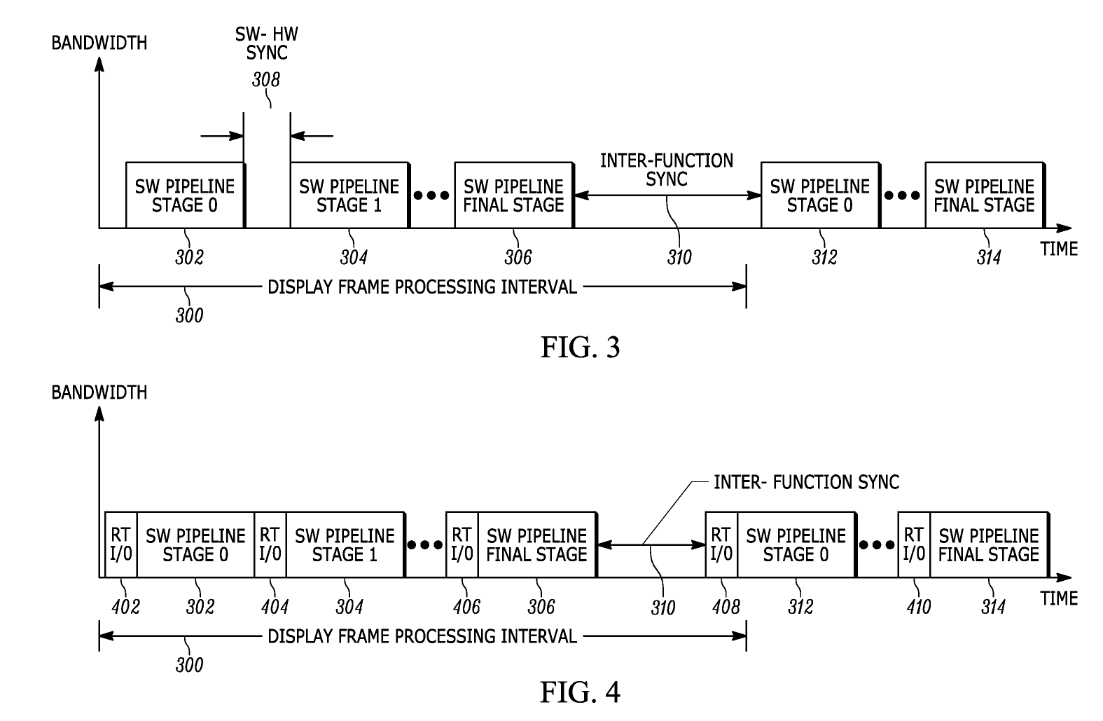

FIG. 3 illustrates a bandwidth profile for an example display frame processing interval 300, which may be associated with a non-real-time processing engine (e.g., the non-real-time processing engine 108). The display frame processing interval 300 represents the processing or rendering of one display frame. As can be seen, there is a plurality of software pipeline stages 302-306 in the display frame processing interval 300, each of which is associated with a different task in the processing or rendering the one display frame. For example, stage 302 may be associated with encoding, while stage 304 may be associated with noise reduction and stage 306 may be associated with video audio packaging. In each of the pipeline stages 302-306, a memory access occurs, which may be performed by different hardware. As such, between each stage, there is a software-hardware synchronization interval 308. The interval 308 exists because the non-real-time processing engine needs time to handle interrupts and prepare for the next stage. As a result, the software-hardware synchronization interval 308 appears as idle memory access time for the non-real-time processing engine. In other words, the interval 308 represents a low memory access activity duration.

In addition, there is an inter-function synchronization interval 310 that exists between stage 306 of the display frame processing interval 300 and the beginning of a subsequent display frame processing interval (as represented by stages 312-314). The interval 310 denotes coordination time between different processing engines. For example, to avoid frame dropping, a GPU must wait for a display engine to finish outputting a frame before moving on to process the next frame. This waiting time also appears as idle memory access time for the non-real-time processing engine, and thus, represents another low memory access activity duration.

Generally, the bandwidth profile of a real-time processing engine (e.g., the real-time processing engine 110) differs from that of the non-real-time processing engine shown in FIG. 3. The main difference is that memory access for the real-time processing engine is constant as I/O access is constant. The peak bandwidth is also much lower than the non-real-time processing engine as there is no need to run faster than the frame rate.

Accordingly, memory access for the real-time processing engine can be partitioned into segments by utilizing the times when there is low memory access activity on the part of the non-real-time processing engine. In particular, the real-time processing engine may execute a memory access during each of the software-hardware synchronization intervals. This is shown in FIG. 4, which illustrates the bandwidth profile of the display frame processing interval 300 but with the software-hardware synchronization intervals being filled or occupied by memory accesses 402-406 from the real-time processing engine. Likewise, memory accesses 408-410 are used to fill or occupy the software-hardware synchronization intervals of the subsequent display frame processing interval (as represented by stages 312-314). In this manner, memory access for the real-time processing engine can be proactively boosted and individual bandwidth demand peaks can be evened out to amortize total demand. Moreover, by having the real-time processing engine perform memory accesses during the software-hardware synchronization intervals, the idling time associated with the inter-function synchronization interval 310 is also reduced.

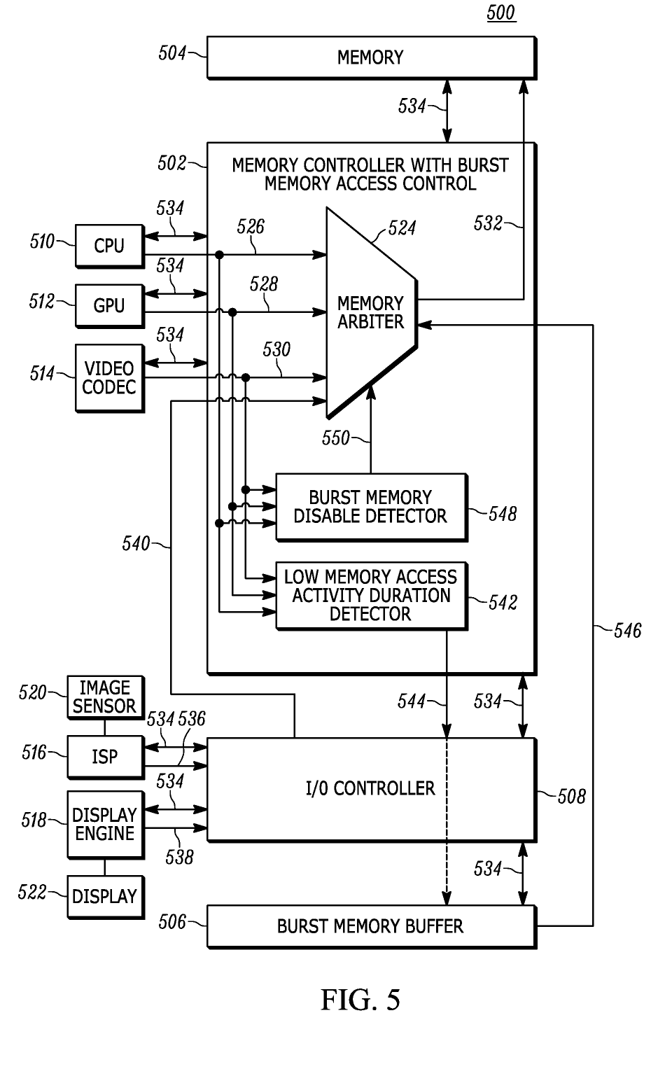

FIG. 5 illustrates one example of an apparatus 500 that provides burst memory access control. The apparatus 500, like the apparatus 100, may be part of a laptop, a smartphone, a videoconferencing system, or any other suitable device or system capable of generating and displaying video and/or other multimedia content. As shown, the apparatus 500 includes, among other things, a memory controller with burst memory access control 502 (which may be similar to the memory controller 102) operatively coupled to a memory 504 (which may be similar to the memory 104), a burst memory buffer 506 (which may be similar to the memory buffer 106) and an I/O controller 508. The apparatus 500 also includes one or more non-real-time processing engines in the form of a CPU 510, a GPU 512, and a video codec 514, operatively coupled to the memory controller 502. Moreover, the apparatus 500 includes one or more real-time processing engines in the form of an ISP 516 and a display engine 518, operatively coupled to the I/O controller 508. The ISP 516 may be associated with an input device such as an image sensor 520 (e.g., a camera, an infrared sensor, etc.), while the display engine 518 may be associated with an output device such as a display 522 (e.g., a display panel, a projector, etc.). Other processing engines (e.g., other real-time processing engines for other I/O devices such as speakers or microphones) can also be included as the number of processing engines is not limited to what is shown in FIG. 5. It is to be appreciated that any suitable number of non-real-time and real-time processing engines may be coupled to the memory controller 502 and the I/O controller 508, respectively.

The memory controller 502 further includes a memory arbiter 524, which arbitrates between various processing engines seeking access to the memory 504. As such, the memory arbiter 524 may include arbitration logic for determining priorities among access requests from the various processing engines, controlling routing of data to and from the various processing engines, handling timing and execution of data access operations, etc.

As the apparatus 500 may operate to process and generate a series of display frames, each of the non-real-time processing engines 510-514 may send out requests (via connections 526-530, respectively) to the memory arbiter 524 to access data stored in the memory 504. In response, the memory arbiter 524 may prioritize the requests (e.g., based on queue occupancy), and give rights to a first non-real-time processing engine to access the memory 504. The memory arbiter 524 may issue a read or write command (via a connection 532) to the memory 504 to allow the first non-real-time processing engine to access the data from the memory 504 (via a data bus 534). Once the first non-real-time processing engine has finished, the memory arbiter 524 may issue another read or write command (via the connection 532) to allow a second non-real-time processing engine to access the memory 504 and so forth.

In a similar fashion, each of the real-time processing engines 516 and 518 may wish to access the memory 504. The real-time processing engines 516 and 518 are coupled to the I/O controller 508, which facilitates transactions between the processing engines 516, 518 and the memory controller 502. In particular, the I/O controller 508 accepts memory access requests from the real-time processing engines 516 and 158 (via connections 536 and 538, respectively), and relays those requests to the memory arbiter 524 (via a connection 540). The memory arbiter 524 may then grant access by allowing the I/O controller 508 to direct the flow of data between the real-time processing engines 516, 518 and the memory 504 (via the data bus 534).

The memory controller 502 provides burst memory access control during display frame processing. To accomplish this, the memory controller 502 further includes a low memory access activity duration detector 542 configured to determine a plurality of low memory access activity durations during a display frame processing interval (see FIG. 3). The low memory access activity duration detector 542 is solely used to monitor the memory access activities of the non-real-time processing engines. In particular, the detector 542 monitors the memory access activities of the non-real-time processing engines 510-514 to determine intervals or durations when the memory access activities of the non-real-time processing engines 510-514 are low. Accordingly, in response to determining the plurality of low memory access activity durations, the detector 542 may generate a control signal for the I/O controller 508 and transmit that control signal to the I/O controller 508 (via a connection 544). Upon receiving the control signal, the I/O controller 508 may relay the control signal to the burst memory buffer 506 in order to initialize and set up the memory buffer 506. In turn, the memory buffer 506 may send a bursting signal to the memory arbiter 524 (via a connection 546). As such, the memory arbiter 524 may be configured to receive the bursting signal from the burst memory buffer 506 to start bursting data for the burst memory buffer 506 in response to the transmission of the control signal to the I/O controller 508. The memory arbiter 524 may allow the I/O controller 508 to direct the bursting of the data from the memory 504 to the memory buffer 506 (via the data bus 534).

The memory controller 502 further includes a burst memory disable detector 548 that monitors memory access requests from one or more of the non-real-time processing engines 510-514. If an important memory access request is received from one of the non-real-time processing engines (e.g., the CPU 510), then the detector 548 generates and sends an interrupt signal (via a connection 550) to the memory arbiter 524. Upon receiving the interrupt signal, the memory arbiter 524 may terminate the bursting of data between the memory 504 and the memory buffer 506. For example, the memory arbiter 524 may notify the I/O controller 508 to stop allowing the bursting of data from the memory 504 to the memory buffer 506 (via the data bus 534). Afterward, the memory arbiter 524 may redirect or reestablish memory access control to the non-real-time processing engine from which the important memory access request was received. This is done so that the non-real-time processing engine does not experience any memory starvation due to the lack of memory access. If no important memory access request is received, then the memory arbiter 524 may continue to allow the bursting of data from the memory 504 to the memory buffer 506. In some embodiments, the memory arbiter 524 may periodically check (e.g., after a real-time burst time out) whether any of the non-real-time processing engines are suffering from memory starvation.

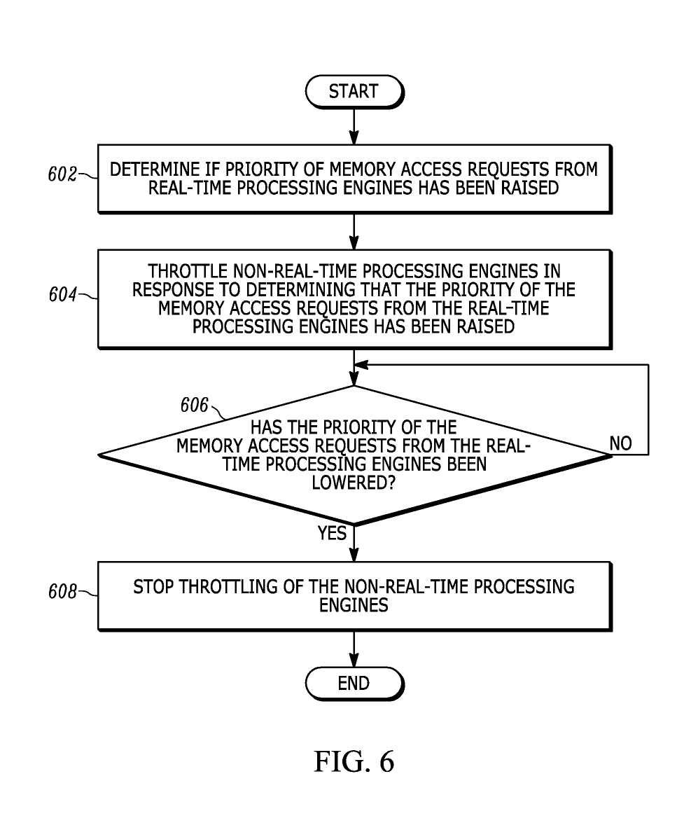

Moreover, the burst memory disable detector 548 may include other functionalities. In particular, the burst memory disable detector 548 may be used to “throttle” the non-real-time processing engines when the real-time processing engines raise the priority of their memory access requests. FIG. 6 shows an example method for throttling the non-real-time processing engines during burst memory access control. At block 602, the method determines if the priority of the memory access requests from the real-time processing engines has been escalated or raised. For example, when a real-time processing engine raises its memory access request priority, that priority escalation information may be fed to the burst memory disable detector 548. At block 604, the method may throttle the non-real-time processing engines in response to determining that the priority of the memory access requests from the real-time processing engines has been raised. Throttling entails that the memory access activities of the non-real-time processing engines are forced to be at a low or minimum level. To do so, the burst memory disable detector 548 may send a signal to all the non-real-time processing engines (or port controllers connecting to those engines) to reduce their efforts of sending requests (or suppress request rate). At block 606, the method determines if the priority of the memory access requests from the real-time processing engines has been lowered or de-escalated. If so, the method proceeds to block 608 to stop the throttling of the non-real-time processing engines. Otherwise, the method stays at block 606. Generally, the memory controller 502 needs to consider fairness when delegating the memory access requests from the real-time processing engines so as to avoid memory starvation for the non-real-time processing engines. By using throttling, the memory controller 502 is freed from fairness concerns, which in turn, helps to improve the overall memory efficiency.

The components 502-522 may be integrated into a single chip. Further, the memory controller 502, the I/O controller 508, and/or the processing engines 510-518 may be implemented as using any suitable hardware, such as an ASIC, a FPGA, a state machine, etc. In some embodiments, the memory buffer 506 may be part of or reside in the memory 504. In some embodiments, the memory buffer 506 may be part of the I/O controller 508. Moreover, in some embodiments, each of the real-time processing engines 516, 518 may be coupled to a separate I/O controller.

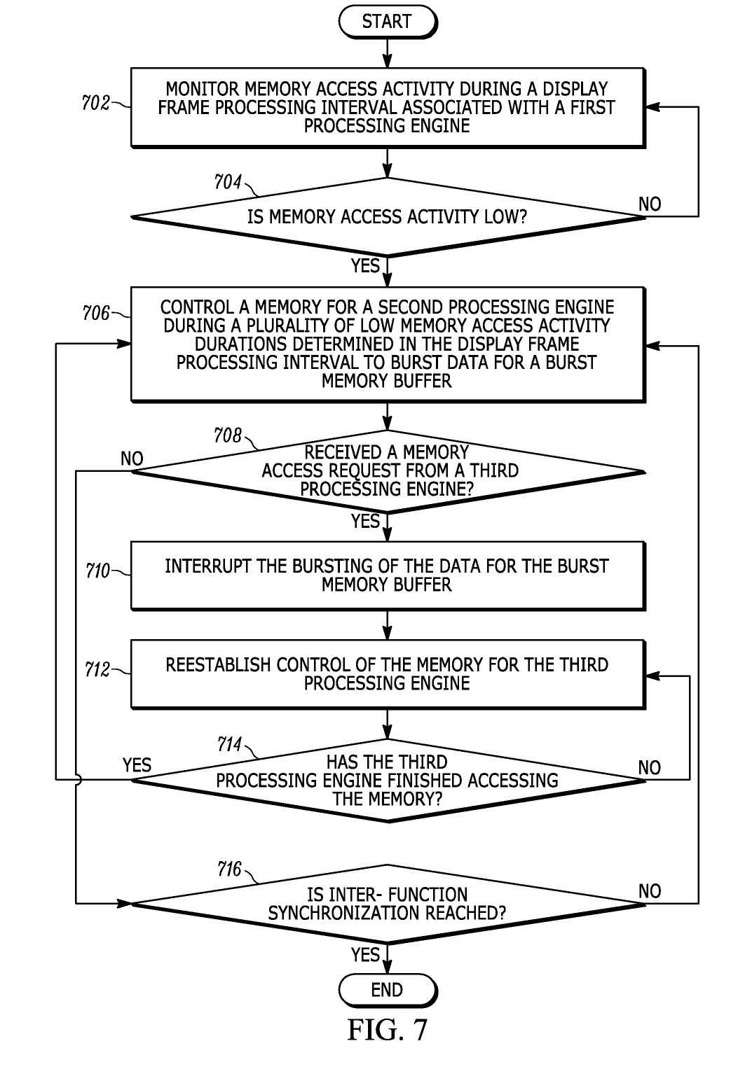

Referring to FIG. 7, an example method for providing burst memory access control will be described. The method may be carried out by a memory controller (e.g., the memory controller 502). As shown in block 702, the method monitors memory access activity during a display frame processing interval associated with a first processing engine (e.g., one of the non-real-time processing engines 510-514). Specifically, the method may monitor the memory access activity to determine a plurality of low memory access activity durations during the display frame processing interval associated with the first processing engine. Determining the plurality of low memory access activity durations may include detecting software-hardware synchronization intervals and detecting an inter-function synchronization interval in the display frame processing interval.

At block 704, if the memory access activity is determined to be low (i.e., if the method finds the plurality of low memory access activity durations during the display frame processing interval), then the method proceeds to block 706. Otherwise, the method loops back to block 702.

At block 706, the method controls a memory for a second processing engine (e.g., one of the real-time processing engines 516, 518) during the plurality of low memory access activity durations determined in the display frame processing interval to burst data for a burst memory buffer. Controlling the memory for the second processing engine to burst the data for the burst memory buffer may include at least one of reading the data from the memory or writing the data to the memory during the hardware-software synchronization intervals. In one example, the second processing engine may be associated with a display engine. As such, reading the data from the memory during the hardware-software synchronization intervals may involve reading pixels from the memory during each of the hardware-software synchronization intervals. In another example, the second processing engine may be associated with an ISP. Accordingly, writing the data to the memory during the hardware-software synchronization intervals may involve writing pixels to the memory during each of the hardware-software synchronization intervals.

At block 708, the method determines whether a memory access request is received from a third processing engine (e.g., one of the non-real-time processing engines 510-514) during the controlling of the memory for the second processing engine. With reference to FIG. 5, the memory controller 502 including the burst memory disable detector 548 may receive a memory access request from the third processing engine during the controlling of the memory for the second processing engine.

If the memory access request is received, the method proceeds to block 710 and interrupts the bursting of the data for the burst memory buffer. Again, with reference to FIG. 5, in response to receiving the memory access request, the burst memory disable detector 548 may generate an interrupt signal to interrupt the bursting of the data for the burst memory buffer.

At block 712, the method reestablishes control of the memory for the third processing engine. Afterward, the method determines whether the third processing engine has finished accessing the memory. If the third processing engine has finished, the method returns to block 706. Otherwise, the method loops back to block 712.

If the memory access request is not received at block 708, the method proceeds to block 716 and determines whether the inter-function synchronization interval is reached. In response to determining that the inter-function synchronization interval is not reached, the method returns to block 706, where the method continues to burst the data for the burst memory buffer.

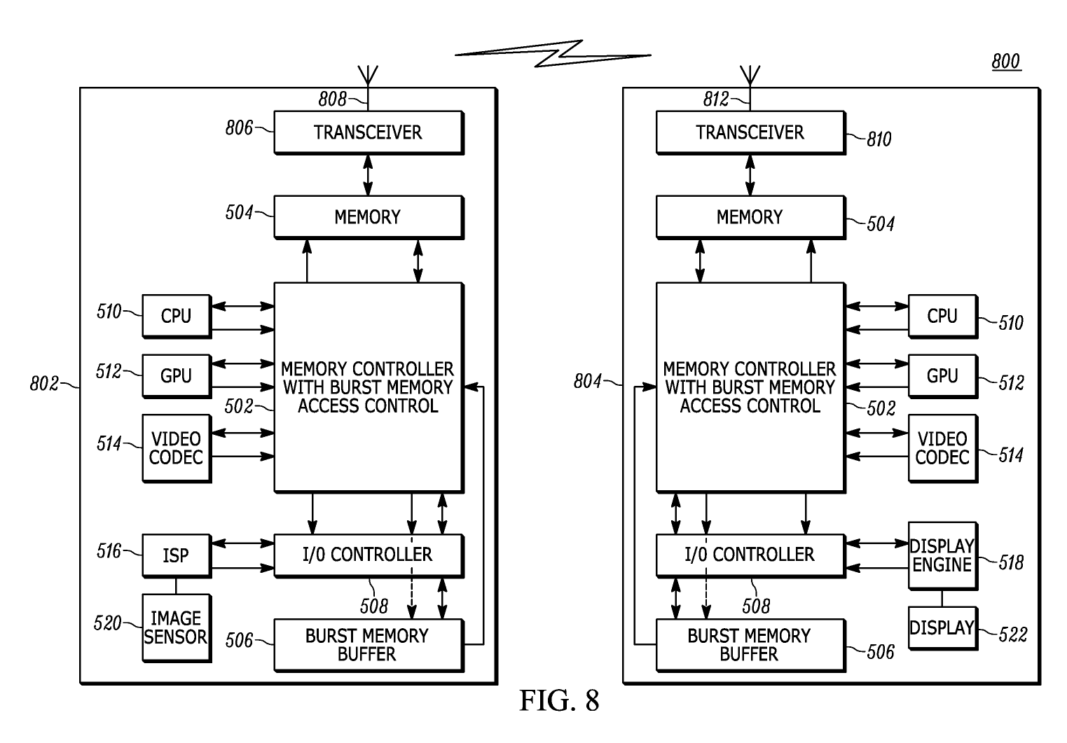

As a further illustration, FIG. 8 shows an example of a videoconferencing system 800 that provides burst memory access control. As shown, the system 800 includes at least two devices 802 and 804. In one example, each of the devices 802, 804 may be a laptop. Each of the devices 802, 804 may include, among other things, the components 502-514 as described in FIG. 5.

The device 802 may operate to capture or record a video and transmit that video to the device 804 for viewing. As such, on the transmitting side, the device 802 includes the ISP 516 and the image sensor 520 (e.g., a video camera). Video data may be captured by the sensor 520, pre-processed by the ISP 516, and transferred to the burst memory buffer 506 of the device 802. When the memory controller 502 of the device 802 detects periods of low memory access activity on the part of the processing engines 510-514 in the device 802, the memory controller 502 of the device 802 may perform burst memory access control to write the video data in the burst memory buffer 506 of the device 802 to the memory 504 of the device 802. The video data can then be encoded and transmitted to the device 804 via a transceiver 806 and antenna 808 (e.g., by using Wi-Fi).

On the receiving end, the device 804 includes the display engine 518 and the display (e.g., a display screen). The device 804 may receive the encoded video data from the device 802 via a transceiver 810 and an antenna 812. The encoded video data may be stored in the memory 504 of the device 804. The encoded video data may be decoded and post-processed. During these operations, the memory controller 502 of the device 804 may detect periods of low memory access activity on the part of the processing engines 510-514 in the device 804. As such, the memory controller 502 of the device 804 may perform burst memory access control to read post-processed video data in the memory 504 of the device 804 to the burst memory buffer 506 of the device 804. In this manner, the display engine 518 can quickly access the post-processed video data for output to the display 522.

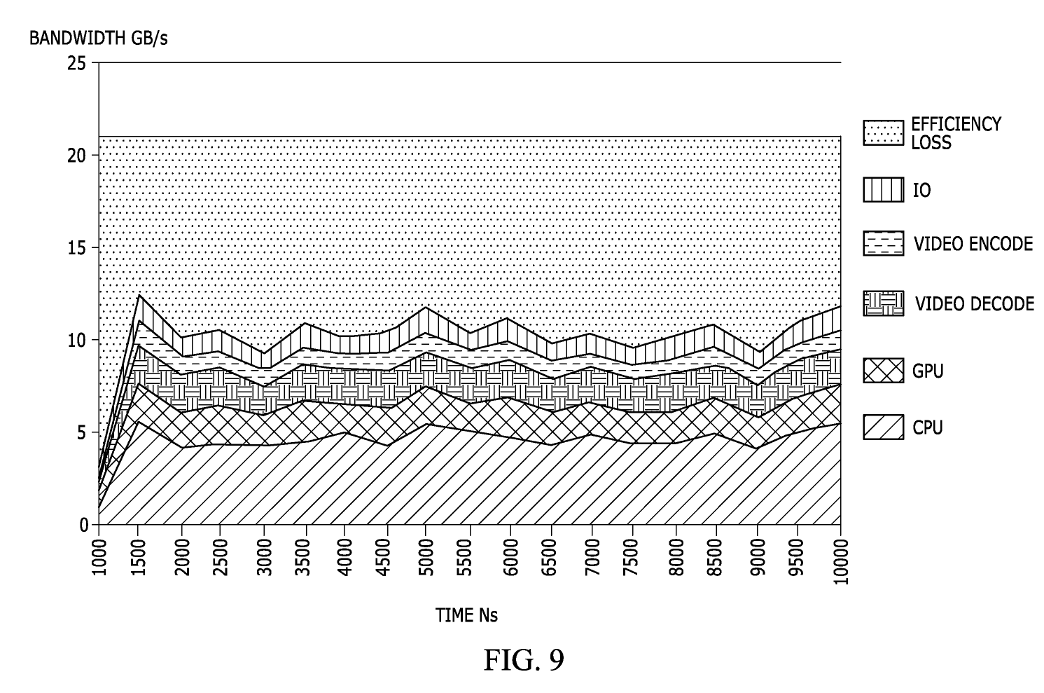

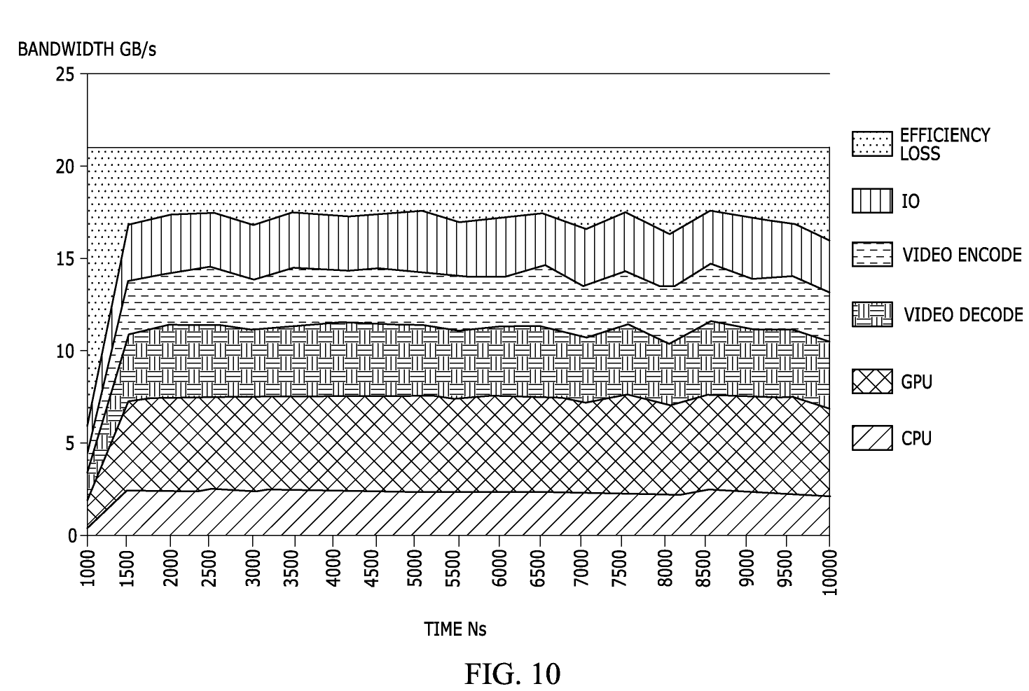

As a further illustration, bandwidth efficiency losses in a system without and with burst memory access control are shown in FIGS. 9 and 10, respectively. As can be seen in FIG. 9, when various non-real-time and real-time processing engines start to work at the same time, memory access requests often compete against each other. Due to this conflict, total bandwidth in the system drops significantly, which results in a large efficiency loss. However, this problem is ameliorated when burst memory access control is employed in the system, where a big improvement in efficiency loss can be seen in FIG. 10.

FIG. 11 illustrates one example of an apparatus 1100 that provides burst memory access control and service rate monitoring. As such, the apparatus 1100 includes, among other things, a memory controller with burst memory access control and service rate monitoring 1102 operatively coupled to a memory 1104 and a burst memory buffer 1106. The apparatus 1100 also includes a non-real-time processing engine 1108, a hard real-time processing engine 1110 and a soft real-time processing engine 1111. Soft real-time refers to the fact that there is no hard requirement on bandwidth or latency. While three processing engines are shown to be coupled to the memory controller 1102, it is to be appreciated that any suitable number of non-real-time, hard real-time and soft real-time processing engines may be coupled to the memory controller 1102.

The memory controller 1102 may operate similarly as the memory controller 102 in FIG. 1. In particular, the non-real-time processing engine 1108 (e.g., a GPU) may send a read request (via a connection 1112) to the memory controller 1102 to access data stored in the memory 1104. In response, the memory controller 1102 may issue a read command (via a connection 1114) to the memory 1104 to allow the non-real-time processing engine 1108 to acquire the data from the memory 1104 (via a data bus 1116). Once acquired, the non-real-time processing engine 1108 may process the data to render display frames. As each display frame is rendered and saved, the hard real-time processing engine 1110 and/or the soft real-time processing engine 1111 may send a read request (via connections 1118 and 1119, respectively) to the memory controller 1102 to retrieve the rendered display frame in the memory 1104. Accordingly, the memory controller 1102 may perform burst memory access control (via a connection 1120) to initialize and set up the burst memory buffer 1106 (e.g., for read/write operations).

In general, the soft real-time processing engine 1111 has its own indicating signal. However, the soft real-time processing engine 1111 does have a set bandwidth, which is used to determine a baseline rate based on the total bandwidth of the memory controller 1102. The baseline rate represents the minimum rate at which the memory controller 1102 would service or handle memory access requests from the soft real-time processing engine 1111. For example, if the soft real-time processing engine 1111 has a set bandwidth of 1 GB/s and the memory controller 1102 has a total bandwidth of 38 GB/s, then the portion of the to the set bandwidth of the soft real-time processing engine 1111 to the total bandwidth of the memory controller 1102 is roughly 2.6%. Thus, the baseline rate for the soft real-time processing engine 1111 is around 3. That is, for every 100 memory cycles of the memory controller 1102, there would be 3 cycles to handle the memory access requests from the soft real-time processing engine 1111. The set bandwidth of the soft real-time processing engine 1111 and the total bandwidth of the memory controller 1102 may be programmable to achieve an arbitrary decimal fraction.

Generally, the memory controller 1102 monitors a service rate (e.g., rate at which memory access requests from the soft real-time processing engine 1111 are serviced) during a programmable current time window. The memory controller 1102 constantly compares the service rate to the baseline rate until the soft real-time processing engine 1111 becomes inactive. However, situations may arise when the memory controller 1102 is preoccupied with performing other tasks or processing other requests from other processing engines. As such, the memory controller 1102 may not be able to meet the baseline rate for handling the memory access requests from the soft real-time processing engine 1111. If this occurs, the soft real-time processing engine 1111 may experience a back pressure in getting its memory access requests through to the memory controller 1102. Moreover, the round trip latency of the back pressure experienced by the soft real-time processing engine 1111 is proportional to the end-to-end path of the pipeline stages and the buffer depth along the path (until the buffer is queued up, the soft real-time processing engine 1111 does not see the back pressure on the request path given that the inflight request constraints are not active at this point). Convergence also contributes to latency on the request and response paths. As a result, it may take some time delay before the soft real-time processing engine 1111 realizes the problem.

To solve this, the memory controller 1102 may monitor the service rate and send out a message (via a connection 1122) to the soft real-time processing engine 1111. In particular, the memory controller 1102 may include a bandwidth monitor and comparator (not shown) for the soft real-time processing engine 1111, which provides the status of the memory controller 1102 to the soft real-time processing engine 1111 during each time window. If more than one soft real-time processing engine is available, then the memory controller 1102 may include a separate bandwidth monitor and comparator for each soft real-time processing engine. Each bandwidth monitor and comparator may know the set baseline rate and device identification for each monitored soft real-time processing engine.

Once the soft real-time processing 1111 receives or obtains the message from the memory controller 1102, the soft real-time processing engine 1111 may decide whether or not to escalate the priority of its memory access requests. To this end, the soft real-time processing engine 1111 includes a signed status counter that increments or decrements depending on the status of the memory controller 1102 indicated in the message (the signed status counter may increment or decrement until saturated). For example, the message may indicate that the service rate satisfies the baseline rate of the soft real-time processing engine 1111. In this scenario, the soft real-time processing engine 1111 may do nothing if priority is not escalated. However, the soft real-time processing engine 1111 may also check its pending request number and the status counter. If neither the pending request number nor the status counter is greater or equal to a negating threshold, then the soft real-time processing engine 1111 may choose to negate priority. Otherwise, the soft real-time processing engine 1111 does nothing.

On the other hand, the message may indicate that service rate does not satisfy the baseline rate. That is, the memory controller 1102 may be too busy to meet the memory access requests of the soft real-time processing engine 1111 at the baseline rate. In this scenario, the soft real-time processing engine 1111 may do nothing if priority is escalated. However, if the priority is negated, the soft real-time processing engine 1111 may also check its pending request number and the status counter. If the pending request number is less than a pending threshold and the status counter is greater than an escalating toggle threshold, then the soft real-time processing engine 1111 does nothing. Otherwise, the soft real-time processing engine 1111 may escalate the priority of its pending request.

If the soft real-time processing engine 1111 chooses not to escalate, then the memory controller 1102 may assume that the soft real-time processing engine 1111 does not have any problem with being served at a rate less than the baseline rate for the current time window. Alternatively or additionally, the soft real-time processing engine 1111 may monitor the service rate by counting responses from the memory controller 1102 during the same current time window (this may be a less optimal approach). By having the memory controller 1102 monitor the service rate and then notifying the soft real-time processing engine 1111, the soft real-time processing engine 1111 is afforded with the opportunity to quickly discover the status of the memory controller 1102, which in turn, lends the soft real-time processing engine 1111 to make prompt decisions regarding the escalation of its memory access requests. In this manner, not only does the memory controller 1102 provide burst memory access control, the memory controller 1102 can also provide status indication that allows the service rate to be promptly reestablished whenever needed or desired.

In some embodiments, it is contemplated that a system would respond with the minimum or least amount of memory bandwidth needed to keep real-time processing engines functional, while providing the rest (or most part) of the total bandwidth to non-real-time processing engines. When the non-real-time processing engines are finished, the system can then serve the real-time engines with the full (or maximum amount of) bandwidth available.

Among other advantages, the methods and apparatus may allow real-time processing engines to proactively submit as many data access requests as possible when overall traffic from the data access requests in system is low. This in turn helps to boost the memory bandwidth of the real-time processing engines by making full use of available bandwidth resources when the system is lightly loaded. Persons of ordinary skill in the art would recognize and appreciate further advantages as well.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto. The above detailed description of the embodiments and the examples described therein have been presented for the purposes of illustration and description only and not by limitation. It is therefore contemplated that the present invention cover any and all modifications, variations, or equivalents that fall within the scope of the basic underlying principles disclosed above and claimed herein.

What is claimed is:

1. A method for controlling memory access to a memory by a memory controller, the method comprising:
determining, by the memory controller, a plurality of low memory access activity durations during a display frame processing interval associated with a first processing engine; and
controlling, by the memory controller, the memory for a second processing engine during the plurality of low memory access activity durations determined in the display frame processing interval to burst data for a burst memory buffer.

2. The method of claim 1, wherein determining the plurality of low memory access activity durations comprises detecting software-hardware synchronization intervals and detecting an inter-function synchronization interval in the display frame processing interval.

3. The method of claim 1, wherein controlling the memory for the second processing engine comprises generating a control signal to initialize the burst memory buffer to start bursting the data for the burst memory buffer during the plurality of low memory access activity durations determined in the display frame processing interval.

4. The method of claim 2, further comprising:
determining, by the memory controller, whether a memory access request is received from a third processing engine during the controlling of the memory for the second processing engine;
in response to determining that the memory access request is received, interrupting, by the memory controller, the bursting of the data for the burst memory buffer; and
reestablishing, by the memory controller, control of the memory for the third processing engine.

5. The method of claim 4, further comprising:
in response to determining that the memory access request is not received, determining, by the memory controller, whether the inter-function synchronization interval is reached; and
in response to determining that the inter-function synchronization interval is not reached, continuing, by the memory controller, to burst the data for the burst memory buffer.

6. The method of claim 1, wherein:
the first processing engine comprises a non-real-time processing engine; and
the second processing engine comprises a real-time processing engine.

7. The method of claim 6, wherein:
the non-real-time processing engine includes one or more of: a central processing unit, an accelerated processing unit, a graphics processing unit, a video codec, an audio codec or a multimedia codec; and
the real-time processing engine includes one or more of: an image signal processor or a display engine.

8. The method of claim 1, further comprising:
providing, by the memory controller, a signal to indicate availability of the memory controller to service memory access requests from the second processing engine.

9. An apparatus comprising:
a memory controller;
a memory operatively coupled to the memory controller;
a burst memory buffer operatively coupled to the memory controller;
a first processing engine operatively coupled to the memory controller; and
a second processing engine operatively coupled to the memory controller;
the memory controller configured to:
determine a plurality of low memory access activity durations during a display frame processing interval associated with the first processing engine; and
control the memory for the second processing engine during the plurality of low memory access activity durations determined in the display frame processing interval to burst data for the burst memory buffer.

10. The apparatus of claim 9, wherein determining the plurality of low memory access activity durations comprises detecting software-hardware synchronization intervals and detecting an inter-function synchronization interval in the display frame processing interval.

11. The apparatus of claim 9, wherein controlling the memory for the second processing engine comprises generating a control signal to initialize the burst memory buffer to start bursting the data for the burst memory buffer during the plurality of low memory access activity durations determined in the display frame processing interval.

12. The apparatus of claim 10, wherein the memory controller is further configured to:
determine whether a memory access request is received from a third processing engine during the controlling of the memory for the second processing engine;
in response to determining that the memory access request is received, interrupt the bursting of the data for the burst memory buffer; and
reestablish control of the memory for the third processing engine.

13. The apparatus of claim 12, wherein the memory controller is further configured to:
in response to determining that the memory access request is not received, determine whether the inter-function synchronization interval is reached; and
in response to determining that the inter-function synchronization interval is not reached, continue to burst the data for the burst memory buffer.

14. The apparatus of claim 9, wherein the first processing engine comprises a non-real-time processing engine and the second processing engine comprises a real-time processing engine.

15. The apparatus of claim 10, wherein controlling the memory for the second processing engine to burst the data for the burst memory buffer comprises at least one of: reading the data from the memory or writing the data to the memory during the hardware-software synchronization intervals.

16. An apparatus comprising:
a memory controller;
a memory operatively coupled to the memory controller;
an input and output (I/O) controller operatively coupled to the memory controller;
a burst memory buffer operatively coupled to the memory controller and to the I/O controller;
a first processing engine operatively coupled to the memory controller; and
a second processing engine operatively coupled to the I/O controller;
the memory controller configured to:
determine a plurality of low memory access activity durations during a display frame processing interval associated with the first processing engine; and
control the memory for the second processing engine during the plurality of low memory access activity durations determined in the display frame processing interval to burst data for the burst memory buffer.

17. The apparatus of claim 16, wherein the memory controller comprises a low memory access activity duration detector configured to:
determine the plurality of low memory access activity durations during the display frame processing interval;
in response to determining the plurality of low memory access activity durations, generate a control signal for the I/O controller; and
transmit the control signal to the I/O controller.

18. The apparatus of claim 17, wherein the memory controller further comprises a memory arbiter configured to receive a bursting signal from the burst memory buffer to start bursting the data for the burst memory buffer in response to the transmission of the control signal to the I/O controller.

19. The apparatus of claim 16, wherein the memory controller comprises a burst memory disable detector configured to:
receive a memory access request from a third processing engine during the controlling of the memory for the second processing engine; and
in response to receiving the memory access request, generate an interrupt signal to interrupt the bursting of the data for the burst memory buffer.

20. The apparatus of claim 16, wherein:
the first processing engine comprises a non-real-time processing engine; and
the second processing engine comprises a real-time processing engine.
